(19) United States
(12) Patent Application Publication
(10) Pub. No.: US 2024/0026189 A1
(43) Pub. Date: Jan. 25, 2024

(54) BIAXIALLY ORIENTED POLYESTER RELEASE LINER, ADHESIVE BACKED ARTICLE ASSEMBLY AND METHOD OF MAKING SAME

(71) Applicant: Pankaj BHATT, Khatima (IN)

(72) Inventor: Pankaj BHATT, Khatima (IN)

(21) Appl. No.: 18/043,030

(22) PCT Filed: Aug. 31, 2021
(86) PCT No.: PCT/IN2021/050838

§ 371 Date: Feb. 26, 2023

(30) Foreign Application Priority Data
Aug. 31, 2020 (IN) 202011037549

(51) Int. Cl. C09J 7/40; C09J 7/38

(52) U.S. Cl. CPC C09J 7/403; C09J 7/401; C09J 7/38; C09J 2467/005

(57) ABSTRACT

The present invention relates to making of a micro textured release liner having a base and micro texture support layer of biaxially oriented polyester film, having at least one side surface suitable for micro texturing followed by an inline or offline release coating and an offline micro texturing process. A micro textured biaxially oriented polyester film release liner is backed with a pressure sensitive adhesive assembly. The micro textured biaxially oriented polyester release liner having at least a release side over to a micro textured layer, a backside, and release coated side surface having a micro texture formed in to the coextruded and biaxially oriented layer of polyester film. A release material is on the micro textured surface of the polyester release liner. The polyester release liner comprises at least a coextruded layer suitable for micro texturing by application of heat and pressure and a micro textured hard surface tool. The micro textured pattern formed on coextruded layer of polyester release liner is designed so as to form fluid egress channels in the pressure sensitive backed assembly. The fluid egress channels define a micro textured surface having exit path ways for fluid to egress out from behind the article when the micro textured surface bonded with pressure sensitive adhesive assembly.

### FIELD OF INVENTION

The present invention relates to making of a micro textured release liner having a base and micro texture support layer of biaxially oriented polyester film, having atleast one side surface suitable for micro texturing followed by an inline or offline release coating and an offline micro texturing process. A micro textured biaxially oriented polyester film release liner is backed with a pressure sensitive adhesive assembly. The micro textured biaxially oriented polyester release liner having atleast a release side over to a micro textured layer, a backside, and release coated side surface having a micro texture formed in to the coextruded and biaxially oriented layer of polyester film. A release material is on the micro textured surface of the polyester release liner. The polyester release liner comprises atlease a coextruded layer suitable for micro texturing by application of heat and pressure and a micro textured hard surface tool. The micro textured pattern formed on coextruded layer of polyester release liner is designed so as to form fluid egress channels in the pressure sensitive backed assembly. The fluid egress channels define a micro textured surface having exit path ways for fluid to egress out from behind the article when the micro textured surface bonded with pressure sensitive adhesive assembly.

### BACKGROUND ART

Micro textured release liners have been used to impart air egress channels in the adhesive surface of pressure sensitive adhesive backed films. Such release liners have included those made with a plastic (ex. polyester) films or paper core having a layer of a thermoplastic polymeric material (ex. polyethylene) laminated or coated to atleast the release side of the liner. However with such polymeric and Paper release liners there are several issues like curling, poor adhesion of micro textured unlike polymers, non-uniform layer of coated or laminated polymer etc. and higher cost. It is also been popular for such release liners to be made with a paper core having a structural support layer of a thermoplastic polymeric material (ex. polyethylene) forming atleast the release side of the liner. More often, the paper core is sandwiched between two layers of thermoplastic polymeric material with one layer forming the release side and the other layer forming the back side of the liner. A release material (ex. silicone) is typically coated on the surface of the release side. A pattern is formed in the plastic structural support layer on the release side of the liner. This pattern is suitable for forming the air egress pattern in the pressure sensitive surface of the adhesive-backed film. The pattern is either formed solely in the corresponding plastic layer or, if the plastic layer is relatively thin compared to the depth of the pattern, into the plastic layer and the core paper. For example, refer Japanese Kokai Patent Application Nos. HEI 11-323790 and HEI 9-141812, and U.S. Pat. No. 6,630,218. In either case, the plastic material structurally supports the pattern formed in the release liner. Such patterns have been formed in the plastic structural support layer heating the thermoplastic material until it softens sufficiently to allow the desired pattern to be embossed or otherwise formed into its surface. Such release liners are referred to as polycoated paper release liners or simply as paper release liners. It is clear that references in the prior art to paper release liners used to impart air egressable pattern in pressure sensitive adhesive surfaces are referring to such polycoated paper release liners. An another popular way for such release liners to be made using a thick Paper having micro texturing on paper itself and a release material bonded to said textured release surface of said paper for example, refer International publication No. WO 2005/052082.

U.S. Pat. No. 7,332,205B2 discloses a release liner comprising a moldable polyolefin layer, a release layer overlying the polyolefin layer, the release layer having a top surface, a plurality of UV cured ink dots having three-dimensional stability embedded into the release layer, the ink dots having a top Surface, wherein the top surface of the ink dots is even with the top release surface of the release layer, wherein the release liner has an embossed raised pattern of microstructures on the top release surface.

U.S. Ser. No. 10/723,919B2 discloses that the texturing is created on the adhesive through release liner after making the assembly.

U.S. Pat. No. 6,315,851B1 discloses a method of making a microstructured pressure Sensitive adhesive article comprising the steps of (a) providing a microstructured molding tool; (b) coating a pressure-sensitive adhesive layer against the microstructured molding tool, wherein the pressure sensitive adhesive layer is capable of assuming the pattern of the microstructured molding tool and retaining the microstructured pattern upon removal from the microstructured molding tool; (c) applying a Substrate to the Surface of the pressure Sensitive adhesive layer; and (d) separating the microstructured molding tool and the adhesive layer to form the microstructured pressure sensitive adhesive article.

The present invention explains the method of making a micro textured release liner where the textured surface is part of base polyester layer so posses the flat surface and minimum curling unlike the ways other ways (ex. lamination or coated etc) layer of unlike polyester material. There is also an issue of poor adhesion of micro textured layer with the base liner layer because of unlike materials. The another issue with such release liners when using a paper release liner is the poor mechanical properties (ex. Tensile strength) and high sensitivity to absorb and outgas moisture which results in slow processing speeds and higher wastages during operation.

The present invention is improvement over several aspects of such prior release liners. Some critical aspects are summarized below:

1. Adhesion of Texture or Microstructure Support Layer with Release Liner:
In most of the prior arts a microstructue or texture support layer is used of polyethylene over Paper or Polyester release liner or other thermoplastic release liner, such release liners due to unlike material layers shows a poor adhesion between the base release liner layer and microstructure or texture support layer and a part of such microstructure or texture support layer comes out easily during further processes.
However it is desirable to have enough adhesion between a texture or microstructure support layer with base layer of release liner.
The present invention provides a method where the said texture layers is part of the release liner and produced together with release liner polyester film, and are of same family polymers.

2. Curling of Release Liner:
In most of the prior arts a microstructure or texture support layer is used of polyethylene over Paper or Polyester release liner or other thermoplastic release liner, such release liners shows severe curling due to the release liner layer materials having unlike thermal shrinkage properties. For example in a structure of Paper and polyethylene when subjected to a heat application the polyethylene layer develops a stress and tend to shrink due to bonded layer with paper this stress creates curling in such release liner. A second example in a release liner of Polyester and polyethylene when subjected to a heat application the polyethylene layer develops a stress and tend to shrink but due to bonded layer with polyester this stress creates curling in such release liner.
However it is desirable to have flat release liner.
The present invention provides a method where the said texture layers is part of the release liner and produced together with release liner polyester film, and are of same family polymers, since polyester is less thermal sensitive thermoplastic so results in a almost flat surface release liner.

3. Texture or Microstructure Loss of Texture or Microstructure Support Layer:
In most of the prior arts a microstructural or texture support layer is used of polyethylene over Paper or Polyester release liner or other thermoplastic release liner. When such release liner subjected to a heat application the polyethylene layer softens and results in a loss of texture dimensions or micro structure, this is especially true when the pattern is a microstructure. Such loss of structure results in poor structural transfer to create fluid egress channels in the pressure sensitive adhesive.
However it is desired to have sharp texture layer so that it can transfer clear fluid egress channels in pressure sensitive adhesive.
The present invention provides a method where the said texture support layers is part of the release liner and produced together with polyester release liner, and are of same polymers family, since polyester is less thermal sensitive thermoplastic so results minimum loss of texture or microstructure during heat application.

4. Thickness of Release Liner:
In most of the prior arts a microstructural or texture support layer is used of Paper, polyethylene over Paper or Polyester film or other thermoplastic films needs to have a high thickness of release liner for minimizing curling by increasing the layer thickness ratio with texture support layer.
However it is desired to have a thin release liner, higher thickness direct associate with the cost.
The present invention provides a possible solution to make a thin release liner.

5. Easy Processing:
The prior arts presented the use of paper as release liner shows difficult processability because of poor mechanical strength of paper, results in breakage and wastages. Poor mechanical strength also relates with slow speed operations. However it is desired to have a mechanically strong release liner.
The present inventive biaxially oriented polyester release liner posses strong mechanical properties.

### SUMMARY OF THE INVENTION

A release liner with Pressure sensitive adhesives backed article have enjoyed great acceptance for their convenience of use. The backed assembly of release liners having pressure sensitive adhesive is often used for protective films (ex. as a surface protection through external contamination like dust or electrostatic charge for electronic articles) and functional films (ex. Graphene films) and articles containing decorative color or images (ex. Advertising boards etc.), paint on the body of a vehicle (ex. Auto-mobile, aircraft, watercraft etc.), equipments, appliances, architecture or any other even or uneven surface substrate. A release liner plays a important role to protect and provide convenience to use such backed articles as such pressure sensitive adhesives posses relatively high strength and high initial bonding tenacity so a release liner supports its simplicity of application. Such Adhesive articles may also be prone to trapping air under the product and forming bubbles or wrinkles when the article is applied to a substrate. Air egress may be referred to as the ability of the product to provide a route for air trapped under the product to be removed. Generally, two separate systems are required to provide an adhesive article with both air egress characteristic. That is, to exhibit characteristic, an adhesive article must include a system to provide air egress. For example, a suitable release liner with micro textured surface can be used over such pressure sensitive assembly in such a way that micro textured surface penetrate inside pressure sensitive adhesive and creates air egress channels.

The present invention provides a micro textured biaxially oriented Polyester release liner for use with an article backed with a pressure sensitive adhesive. The present invention provides such a release liner that is suitable for a Ultraviolet curable, solvent borne or water borne pressure sensitive adhesive, where the solvent or water is typically driven off by heat during the application. The pressure sensitive adhesive preferably exhibits pressure sensitive adhesive properties at room temperature. One such adhesive-backed article can be a film or other sheet materials such as, protective films (ex. as a surface protection through external contamination like dust or electrostatic charge for electronic articles) and functional films (ex. Graphene films) and articles containing decorative color or images (ex. Advertising boards etc.), paint on the body of a vehicle (ex. Auto-mobile, aircraft, watercraft etc.), equipments, appliances, architecture or any other even or uneven surface substrate.

The structural support layer on the release side of prior art polycoated paper release liners is usually a thermoplastic polymer that softens when heated so that it can be micro textured with a pattern that can be used to impart an air egress channels to the bonding surface of a pressure sensitive adhesive. The thermoplastic nature of such patterned structural support layers, however, can result in one or more of several limitations in its use. For example, anytime the textured release liner is heated generally for release coating application, it can result in a loss of pattern texture formed in the thermoplastic structural support layer. This is especially true, when the pattern texture is a microtexture so a UV curable release coating is preferred to avoid such phenomenon.

Some pressure sensitive adhesives that could be cast or coated directly on to a textured polycoated release liner need to be processed (e.g., coated, cured or dried) at high temperatures. For example, hot melt type pressure sensitive adhesives (ex. low viscosity acrylic pressure sensitive adhesive) need to be heated to relatively high temperatures upto 200° C. to lower their viscosity enough to enable the pressure sensitive adhesive to fill and replicate the pattern texture on the release liner. Such high temperatures can easily be above the temperature at which the thermoplastic structural support layer begins to soften (ex. polyethylene layer will begin to soften at about 95° C.). If the thermoplastic layer on the polycoated release liner softens during such high temperature processing, all or part of the micro texture formed in the structural support layer can be degraded or lost. Other high temperature processing that could, atleast potentially, have such a detrimental effect on the pattern texture in the polycoated release liner include circumstances where one or more additional layers or coatings (ex. one or more topcoats) are applied to then on-textured surface of adhesive that will be bonded to an article. In addition, patterned structural support layers made of thermoplastics like polyethylene can become tacky or sticky when heated. Especially with polycoated paper liners having a polycoat on both sides, the backside of the liner can become tacky and adhere to the equipment used to move the liner along during processing (ex. contact rollers of web-handling equipment). Such a tacky backside of the liner may also adhere to the top surface of the article when, for example the adhesive backed article assembly is wound in to a roll while the liner's backside is still tacky. Another potential example is when a solvent-borne pressure sensitive adhesive is used and the structural support layer, like a polyethylene coating, can absorb solvents from the pressure sensitive adhesive being used. In cases where such pressure sensitive adhesives must be cured and/or dried at relatively high temperatures, the absorbed solvent appear to cause blistering and formation of bubbles in the polycoated paper release liner as the adhesive is cured/dried. Another potential advantage of the present inventive textured paper release liner relates to role stability (e.g., telescoping). Polycoated release liners can be difficult to handle because their surfaces can have a relatively low coefficient of friction. The surfaces of the present micro textured biaxially oriented polyester film release liner will exhibit relatively controlled friction coefficients, making them less likely to be telescopic. The structural support layers of prior art polycoated release liners can also be harder to print on than the present textured micro textured polyester release liner.

In one aspect of the present invention, such a micro textured release liner is provided that comprises a layer of polyester film and a release material. The layer of polyester film typically biaxially oriented in roll forms, has a release side with a micro structural support layer formed via coextrusion during the manufacturing of polyester film itself followed by a micro texturing process on the release side. As used herein, a micro textured support layer is defined as a continuous polyester layer that is capable of having a textured pattern, where the pattern is either completely contained within the layer of polyester. Examples of release liners that include such a structural support layer can be found in Japanese Kokai Patent Applications Nos. HE!11-323790 and HE!9-141812, and U.S. Pat. No. 6,630,218. The textured release surface can be a micro textured release surface with a micro textured pattern formed in to the release side of the paper. Such micro textured patterns can be those that have individual features with at least one dimension of less than 50 micrometers. Examples of such micro textured release surfaces and patterns can be those found, for example, in PCT Publications Nos. WO00/69985 and WO95/11945, and U.S. Pat. No. 5,141,790, which are in corporate herein by reference in their entirety. The release material is substantially adhered to, permanently adhered to or otherwise bonded to the micro textured release surface of the polyester film, and preferably on all, or substantially all, of the textured release surface that will come in contact with the pressure sensitive adhesive. That is, there is a sufficient amount of release material to provide acceptable release forces between the release liner and the adhesive-backed article. The micro texture texture formed in the polyester film is designed and dimensioned, or otherwise operatively adapted, so as to form fluid egress channels in a bonding surface of the pressure sensitive adhesive. As used herein, the term fluid egress channels refers to channels that provide egress for air, water or other fluids. The pattern can be formed in the pressure sensitive adhesive applying the pressure sensitive adhesive on to the micro textured release surface such that the adhesive conforms to the pattern in the release coated micro textured polyester film. The pattern in the pressure sensitive adhesive can also be formed by the pattern in the polyester release liner being embedded in or otherwise forced to penetrate in to the pressure sensitive adhesive such that the adhesive conforms to the pattern in the micro textured polyester film. The fluid egress channels define a textured bonding surface having exit path ways for atleast some or all of the fluid to egress from behind the article when the article is adhered to a substrate, and preferably when the article is adhered to a smooth surface on the substrate. The texture formed in the polyester film can be designed so as to form such fluid egress channels. In such textures atleast one dimension must be more than 10 micrometers.

After texturing, The biaxially oriented polyester release liner shall reduce its volume maximum by 90.25% so as to form such fluid egress channels that define a volume of atleast 0.028 μm³ per 1 μm³ of textured layer volume and/or will be substantially undetectable on an upper or exposed surface of the article (i.e. the surface of the article opposite the structured bonding surface), after final application of the article on to a substrate and, preferably, even when the article is an adhesive backed compliant film. That is, the channels are sufficiently undetectable on the upper surface so that the appearance of the exposed surface of the applied article will not be substantially affected adversely by the channels.

The final application of the article on to a substrate typically involves the application of a required level of pressure in order to obtain a required level of adhesion with the substrate. This usually results in a high degree of wet out by the adhesive on the substrate. The pattern formed in the release side of the paper liner can provide a outwardly extending protrusions from the surface of release side so as to penetrate and form the fluid egress channels, and other possible textures, in the textured bonding surface of the pressure sensitive adhesive. The pattern formed in the polyester film liner can also be designed so as to provide a inwardly extending cavities or other depressions that form protrusions in the pressure sensitive adhesive that creates the fluid egress channels, and other possible textures, in the bonding surface of the adhesive. The texture formed in the polyester film liner can also comprise a outwardly extending protrusions and/or inwardly extending depressions that are sized and shaped (ex. Polygon shapes, square pyramidal shaped, parallel lanes etc.) so as to form fluid egress channels in the pressure sensitive adhesive.

The polyester film release liner made by coextrusion with ABC or AB structure, wherein the layer A (texturing layer) is a copolymer of polyester or a blend of homopolymer and copolymer of polyester and layer B is homopolymer of polyester, the layer C is optionally can be any of homopolymer or copolymer of polyester if required for certain functional properties on opposite side of release liner. The structural ratio of release liner to be maintained in such a manner to maintain the A layer (texturing layer) thickness to be minimum 5 micrometer. The polyester resin or melt is passed through extruders and casted on a cooled steel roll to form a cast sheet which further passed through a series of hot rollers to stretch cast film in longitudinal direction at a draw ratio preferably between 2 to 3.5 times. The film further passed through the series of cooling rollers. This mono axially stretched film optionally passed through a single side or both side coater. The layer A (texturing layer) is coated by a water borne release coating (ex. Silicone) and optionally the other side of the polyester film with print enhanced or other surface functional coatings. The mono axial oriented coated film then passed through the tenter where the applied coating on mono axial oriented film get dried and stretched in transverse direction in a draw ration between 2.5 to 5.5 at temperature between 85° C. to 110° C. The Biaxially stretched film then heat set at higher temperatures between 200° C. to 245° C. followed by winding. The film may contain recycling polyester resin or polyester film fluff in a ratio not more than 50%. The thickness of polyester film has a thickness between 23 micrometers to 300 micrometers. Additionally such biaxially oriented release liner can be made in any color. The release coating (ex. Silicone) can also be applied to the polyester release liner after making the film by any suitable release material and can include silicone release materials such as, for example, ultraviolet or heat curable silicone release material preferably before micro texturing the polyester release liner. The relatively less sensitivity to high temperatures exhibited by the present inventive polyester release liner allows for more types of release materials to be used, to be more completely cured and/or to be processed at faster rates, because prior polycoated paper release liners are sensitive to high temperatures, silicone release materials applied to such release liners can only be coated and cured at relatively low temperatures. As a result, the silicone release layer is typically either not cured completely or the curing processes is extended (i.e., the process is slowed). Not curing the release material completely increases the likelihood of the release material transferring to and contaminating the pressure sensitive adhesive. Slowing the curing process reduces efficiency and increases costs.

In another aspect of the present invention the present release liner is provided in combination with an article backed with a UV curable or solvent or water based pressure sensitive adhesive so as to form an adhesive-backed article assembly. The pattern formed in the polyester film is embedded, penetrated or otherwise in the adhesive so as to form a textured bonding surface on the adhesive, with fluid egress channels that define exit pathways, which preferably provide a continuous fluid egress to a periphery of the article, for fluid to egress from behind the article when the textured bonding surface is adhered to or otherwise disposed on a substrate, and preferably when the article is adhered to a smooth surface on the substrate. The compliant film can have a thickness that is usually in a range about 300 micrometer or less, and preferably about 23 micrometer to about 100 micrometer for some compliant decorative films.

In an additional aspect of the present invention, a method is provided for making a micro textured polyester release liner, like that described above, which can be used with an article backed with a pressure sensitive adhesive.

The method comprises making of a biaxially oriented polyester film through coextrusion in a layer structure of AB or ABC wherein the layer A is coated by release material preferably silicone, typically in roll form, having a release side is micro textured by a hard textured tool preferably in form of roll, otherwise forming a pattern in the release side, and so as to produce a textured release surface on the release side, the pattern formed in the release side of polyester film being designed or otherwise operatively adapted so as to form fluid egress channels in a bonding surface of the pressure sensitive adhesive (ex. when the pressure sensitive adhesive is cast, coated or otherwise applied on to the textured release surface or when the pattern is embedded in or otherwise penetrates in to the adhesive), such that the fluid egress channels define a textured bonding surface having exit pathways for fluid to egress from behind the article when the article is adhered to a substrate, and preferably when the article is adhered to a smooth surface on the substrate; and coating, laminating or otherwise depositing, applying or otherwise providing a release material so as to substantially, and preferably permanently, adhere or otherwise bond to the release side of the polyester film, either before or after forming of the textured release surface of the polyester film, and preferably on all, or substantially all, of the release side forming the textured release surface that will come in contact with the pressure sensitive adhesive. The pattern is preferably formed in the pressure sensitive adhesive by casting, coating or otherwise applying the pressure sensitive adhesive on to the textured release surface such that the adhesive conforms to the pattern in the polyester film. The pattern in the pressure sensitive adhesive may be formed by the pattern in the polyester liner being embedded in or otherwise forced to penetrate in to the pressure sensitive adhesive such that the adhesive conforms to the texture in the polyester film.

In this method, the texturing can be done without imparting a substantial portion of the pattern through to the backside of the polyester film i.e. while maintaining the backside of the polyester film substantially flat and/or smooth. Factors such as the thickness and density (ex. White polyester film lowered density) of the polyester release liner, as well as the type of back support the release liner during the pattern forming operation, can determine whether a portion of the pattern forms through to the backside of the liner. For example, if the pattern is formed by processing the release liner through a metal embossing nip roller and a metal or hard rubber (ex. Shore hardness >95) backing roller, the pattern is less likely to form through to the backside of the liner. If a rubber backing nip roller (Low hardness) is used, it is more likely that part of the pattern will form through to the back side of the liner. The release liner can also further comprise a structural support layer or some other support material on the backside of the paper. The release liner can also not include a structural support layer or some other support material on the backside of the polyester film.

In a further aspect of the present invention, a method is provided for making an adhesive backed article assembly. The method comprises providing a textured paper release liner like that described above and providing a pressure sensitive adhesive. The adhesive articles have a continuous adhesive layer typically a pressure sensitive adhesive layer. The adhesive thickness layer typically had a thickness from about 8μ to 50μ. The coat weight of adhesive typically had a range of about 10 to 50 grams per square meter (gsm). The pressure sensitive adhesive can be any pressure sensitive adhesive known in the art. These include rubber based adhesive, acrylic adhesives, vinyl ether adhesives, silicone adhesives and mixture of two or more thereof. Included are the pressure sensitive adhesive materials described in “Adhesion and Bonding”, Encyclopedia of Polymer Science and Engineering, Vol1, Pages 476-546, Interscience Publishers, 2^{nd} edition 1985, the disclosure of which is hereby incorporated by reference. The pressure sensitive adhesive can be applied using the standard coating techniques, such as curtain coating, gravure coating, Reverse gravure coating, Offset gravure coating, roller coating, brushing, knife over roll coating, air knife coating metering rod, doctor knife coating, dipping, die coating, spraying and the like. The application of these coating techniques is well known in the industry and can effectively be implemented by one skilled in the art.

The method can also comprise bringing together the pressure sensitive adhesive and the textured release surface of the biaxially oriented polyester film release liner (ex. by casting, coating or otherwise applying the pressure sensitive adhesive on to the textured release surface and/or forcing the textured release surface in to the pressure sensitive adhesive) so as to form fluid egress channels in the pressure sensitive adhesive. The method can additionally comprise laminating or otherwise bonding together the pressure sensitive adhesive and the back of an article to form an adhesive backed article. The method can further comprise forming the adhesive-backed article assembly by either performing the bonding together and then the bringing together or performing the bringing together and then the bonding together. The fluid egress channels define a textured bonding surface of the adhesive backed article having exit path ways, which preferably provide a continuous fluid egress to a periphery of the article, for fluid (ex. air) to egress out from behind the article when the textured bonding surface is adhered to or otherwise disposed on a substrate, and preferably when the article is adhered to a smooth surface on the substrate.

### BRIEF DESCRIPTION OF THE DRAWINGS

FIG. 1: is a preferred method for producing a release liner in accordance with aspects of the invention.

FIG. 2: is a representative cross sectional view of the textured release liner in accordance with the principles of the present invention.

FIG. 3: is a Top view of the textured release liner in accordance with the principles of the present invention.

FIG. 4: is a representative cross sectional view of an adhesive based article assembly according to an embodiment of the present invention with a textured polyester release liner having a pattern in its release side formed by texturing tool as in FIGS. 6 & 7.

FIG. 5: is a representative cross sectional view of an adhesive based article assembly after detaching of release liner according to an embodiment of the present invention with a textured polyester release liner having a pattern in its release side formed by texturing tool as in FIGS. 6 & 7.

FIG. 6: is a representative of top view of a texturing tool according to an embodiment of the present invention.

FIG. 7: is a representative of side view of a texturing tool according to an embodiment of the present invention.

FIG. 8: is a representative method of bringing together the pressure sensitive adhesive and the biaxially oriented polyester film textured release liner.

### DETAILED DESCRIPTION

In one embodiment of the present invention, a micro textured biaxially oriented polyester film release liner is provided for use for an article backed with a solvent or water borne pressure sensitive adhesive. One such adhesive backed article can be a pressure sensitive adhesive backed compliant film or other sheet material such as, for example Protective films (ex. as a surface protection through external contamination like dust or electrostatic charge for electronic articles) and functional films (ex. Graphene films) and articles containing decorative color or images (ex. Advertising boards etc.), paint on the body of a vehicle (ex. Auto-mobile, aircraft, watercraft etc.), equipments, appliances, architecture or any other even or uneven surface substrate.

Referring to FIG. 1, the present inventive biaxially oriented polyester release liner is produced via coextrusion process followed by biaxial orientation and texture layer is a part of such release liner film and not like a conventional polycoated paper or film release liner. The liner has a release side, which is having a coextruded textured layer of like polymers and created at the time of making the film, and a backside. The release side is coated with a conventional release material preferably a silicone release material, for example, via inline coating or offline conventional application techniques. The texture typically includes a peak or high feature and a valley or low feature.

The polycoated structural support layer can be defined herein as any of the structurally supportive layer of resin material that have been coated Or laminated on to paper and used to form any of the prior art textured release liners such as, for example, those found in International Publication No. WO00/69985A1 (i.e. U.S. Pat. No. 6,524,675), U.S. Pat. No. 5,650,215, and the Japanese Patent Application No. Hei 7-300232 (Unexamined Publication No. Hei 9-141812), filed Nov. 17, 1995 (Published Jun. 3, 1997), entitled Embossing Release Paper and Its Manufacturing method. Such structural support layers are continuous thermoplastic or thermosetting polymeric layers that are embossable.

The present inventive biaxially oriented polyester release liner may optionally have a copolyester of polyester layer suitable for micro texturing or any other functional coated layer on its backside that may provides a degree of dimensional, micro texture and/or other functional coating (ex. For print adhesion, anti-counterfeiting etc.). It can be desirable for the backside of the present inventive release liner to be relatively flat. It can also be preferable for the backside of the present liner to be relatively flat such as, for example, when the backside of the liner comes in contact with the top side of the adhesive backed article and, in particular, the top side of adhesive backed decorative films. The back side of the liner can come in to contact with the topside of the article, when the resulting assembly is wound in to a roll or when a protruded dimensions of such assemblies are stacked one on top of the other. The texture created in to the biaxially oriented polyester release liner by compressing a designed hard tool according to the texture required on the release liner to form or maintain fluid egress channels in the textured pressure sensitive adhesive that define functional exit path ways (i.e. exit path ways that allow fluid to egress out from behind the article when the article is adhered to a substrate surface).

The present inventive release liner also exhibit an another advantage over previous paper release liners that present biaxially oriented polyester release liner have sufficient structural integrity even used at lower thicknesses so it can easily be removed from the pressure sensitive adhesive in one piece instead of breaking apart in to small pieces when the user tries to remove it.

The present inventive release liner is used to produce a desired micro texture on the bonding surface of an adhesive, typically a pressure sensitive adhesive that may be a solvent borne or emulsion based pressure sensitive adhesive or the like. The desired texture features can be imparted to the adhesive by the textured release surface of the present release liner, which was previously textured, or otherwise formed, with the desired texture dimensions. The adhesive may also be coated on to a substrate, and laminating with the release liner on to it to form the features in the adhesive.

The method of making such biaxially oriented polyester film release liner can be prepared via the utilization of a coextrusion, casting and sequential stretching via suitable hardware. An multilayer coextrusion process involves a main extruder (2) used to produce the core or major layer of polyester film. On to the surfaces of the core layer other layers deposited through the use of secondary extruders (1 & 3). The surfaces of the core layer can be deposited by the same or modifier polymers of polyester. The polyester film layer combination can be ABC (where two different polymers/copolymers of polyester deposited on the surface of core layer), AB (where there is no additional layer deposited on one side of core layer), ABA (where there is same layer of polymer deposited on the surfaces of core layer). These extruders preferably feed the melt pump system (4) and (5) to maintain the output of the layers constant and not substantially influenced by viscosity changes of the molten polymer. This molten polymer further filtered through fine steel filters (6) before laminating the multi melt layers, each molten polymer layer is separated through filtration system. After filtration, the melt polymer layers are laminated together to form a continuous layers of molten polymer in a feedblock assembly and die (7). Now this multilayer molten polymer is quenched onto a cooled rotating steel drum (8), often referred to as a casting drum or chill roll to produce a solid amorphous sheet of polyester. This sheet is stretched in machine direction or forward direction through a set of heated rollers or stenter (9), to stretch cast film in at a draw ratio preferably between 2 to 3.5 times. The film further passed through the series of cooling rollers after stretching in the forward or machine direction, the film surfaces can be treated on either or both surfaces by the use of corona treaters (10). In the case of inline coating the surface or surfaces of polyester film is preferably treated to enhance the adhesion of coatings to the polyester substrate comprising the in the polyester film.

There are many methods to do surface coating on the monoaxially or uniaxially oriented polyester film. Such methods include such as a kiss roll coating, Gravure roll coating, Mayer bar coating, Air Knife coating, D bar coating, transfer roll coating among others are well known to those skilled in the art. Preferable methods include gravure roll, Transfer roll and rod coatings. In the case of Transfer roll coating the coating thickness is a limitation and difficult to achieve high coat weights. In case of rod coating it is difficult to achieve a uniform thickness coating. Furthermore a both surface coating is desired when any other or same functional surfaces are desired on the both surfaces of the polyester film, for instance to produce a film having one surface coated by a release coating and other surface by a suitable print adhesion coating. As shown in the FIG. 1, the either surface of uniaxially oriented polyester film can be coated via inline coating system (11). The layer A (texturing layer extruded by coextruder (1)) is coated by a water borne release coating (ex. Silicone) and optionally the other side of the polyester film with print enhanced or other surface functional coatings.

After coating the coextruded uniaxially oriented polyester film the film passed through the preheat zones of stenter (12) where the applied coating on mono axial oriented film get dried before stretching in transverse direction. The uniaxially stretched film further stretched in sideways or transverse or cross machine direction in zones (13) in a draw ration between 2.5 to at temperature between 85° C. to 110° C. The film further heat set or annealed at higher temperatures between 200° C. to 245° C. and cooled in zones (14) to produce a biaxially oriented coated polyester film. The film is then passed through the take up transfer unit (15), a set of rollers helps to prevent any winding defects, further corona treatment on either side if required, then inspected for surface defects (ex. Coating marks, Water patch, Unmolten polymer, Dust mark etc.) at station (16) after biaxially orientation and then wound into jumbo rolls or rolls at (17).

The polyester film release liner made by multilayer coextrusion systems as explained above, In case of ABC layer structure, wherein the layer A (texturing layer extruded by coextruder (1)) is a copolymer of polyester or a blend of homopolymer and copolymer of polyester and layer B (extruded by core layer extruder (2) is homopolymer of polyester, the layer C (extruded by core layer extruder (3) is optionally can be any of homopolymer or copolymer of polyester if required for certain functional properties on opposite side of release liner. In case of ABA layer structure, wherein the layer A (texturing layer extruded by coextruder (1)) is a copolymer of polyester or a blend of homopolymer and copolymer of polyester and layer B (extruded by core layer extruder (2) is homopolymer of polyester. In case of AB layer structure, wherein the layer A (texturing layer extruded by coextruder (1)) is a copolymer of polyester or a blend of homopolymer and copolymer of polyester and layer B (extruded by core layer extruder (2) is homopolymer of polyester. The structural ratio of biaxially oriented polyester film release liner to be maintained in such a manner to maintain the A layer (texturing layer) thickness to be minimum 4 micrometer. The film may contain recycling polyester resin or polyester film fluff in a ratio not more than 50%. The thickness of release liner has a thickness between 23 micrometers to 300 micrometers. Such release liner can be made in any desired color by addition of suitable color polymer masterbatch during the film production.

Homopolymers and copolymers may be obtained by transesterification or direct esterification by known methods as described by D. A. Schiraldi in “New Poly(directethylene Terephthalate) copolymers” from the book “Modern Polyesters Chemistry and Technology of Polyesters and Copolyesters” Edited by John Scheirs and Timothy E. Long, pp. 245-262. John Wiley & Sons, 2003. A melted slurry of diol or substituted diol and purified dibasic acid or with substituted diacid or with esters of diacids is heated, in the presence of a esterification catalyst and water/methanol and excess diol are removed under vacuum leaving a residual melt of the polyester which is discharged via strand die into a cooling trough. The resin then pelletized and further dried to remove residual moisture to less than 100 ppm. Trimethylphospate of 0.032 wt %, magnesium acetate of 0.060 wt %, antimony trioxide of 0.026 wt % and tetraethyl ammonium hydroxide of 0.252 wt %, were also added to prepare homopolyester. The polycondention process carried out at 140° C. to 290° C. and at a pressure of 1 mm. The inorganic particles slurry in diol is added prior to polycondensation process. Inorganic particles are selected from particle size of 0.5 to 7μ preferably 0.5 to 3μ and are added in amount 300 to 2000 ppm, preferably 700 to 1500 ppm. The inorganic particles are made into dispersion in a carrier liquid such as mono-ethylene glycol or optionally added into master batches of polyester or copolyester. Polyesters such as dimethyl terephthalate is preferred, more specifically polyethylene terephthalate, polybutylene terephthalate, polycyclohexane dimethanol terephthalate, polyethylene alpha beta-bis (2-chloro or 2-methoxyphenoxy) ethane-4, polyethylene (tere/iso/ortho) phthalate including those produced by using more than one dibasic acid selected from terephthalic acid, isophthalic acid, adipic acid, azalaic acid, orthophthalic acid, sebacic acid, naphthalene dicarboxylic acid and the like and more than one diol selected from ethylene glycol, diethylene glycol, triethylene glycol, butane diol, neopentyl glycol, cyclohexane dimethanol and the like. The dicarboxylic esters are selected from dimethyl terephthalate, dimethyl isophthalate, dimethyle sebacate, dimethyl adipate, naphthalene dicarboxylate and their like. Copolyester such as amorphous polyethylene terephthalate for the purpose of this invention was obtained by transesterification of mixture of mono ethylene glycol, Diethylene glycol, 1-4 cyclo hexane dimethanol and dimethyl terephthalate in the presence of preferably manganese acetate catalyst at 140° C. to 230° C. The polycondensation reaction was carried out preferably in presence of Antimony Trioxide catalyst and triphenyl phosphate heat stabilizer at 260° C. to 290° c. up to 1 mmHg pressure. The base material for the film selected from those having intrinsic viscosity in range of 0.58 to 1.2 dl/g. A blend of polyesters may also be used having the intrinsic viscosity within the said range.

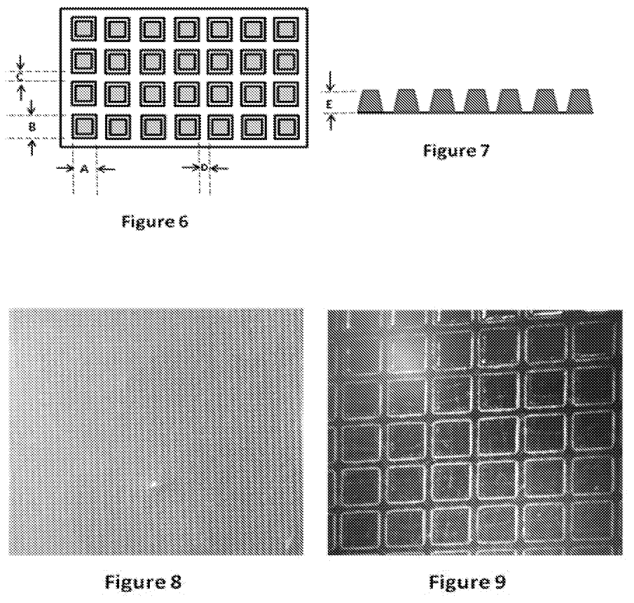

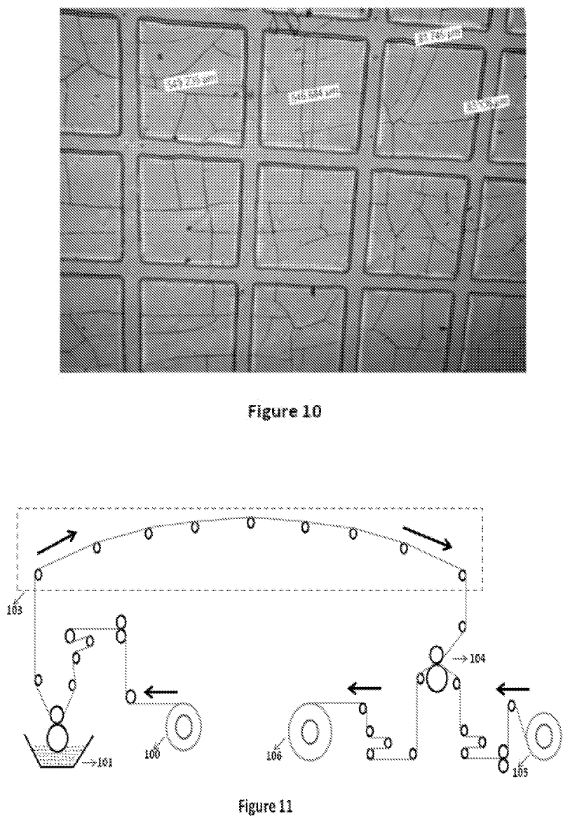

The invention present a method of texturing the biaxially oriented polyester release Liner, biaxially oriented polyester release liner has the texture on the release surface of biaxially oriented polyester film release liner. The texture may or may not be micro textured. Patterns that can be used in the process are generally described in the art in patents such as, for example, PCT Publications Nos. WO00/69985 and WO95/11945, and U.S. Pat. No. 6,197,397 (Sheretal), (Calhounetal.), U.S. Pat. No. 6,524,675 (Mikamietal.) and U.S. Pat. No. 5,650,215 (Mazureketal.). Examples of suitable patterns for a tool's texturing surface are square based pyramids and triangular based pyramids with sharp and blunt tips, as well as arrays of linear intersecting (cross-hatched) or non-intersecting ridges, linear patterns with a curved geometry, linear v-grooves and cube or cuboid pattern (ex. refer FIGS. 6 and 7). The resulting pattern imparted to the biaxially oriented polyester release liner parallel intersecting lanes. Other suitable patterns may include lenticular shapes, hemi spheres, ellipses, gum drops, pillows, honey combs, square grids, random patterns, or other arrays.

The biaxially oriented polyester release liner can be textured by mechanical means using a tool such as embossing nip rollers (ex. an embossing roll backed by a backing roll), an embossed plate, a hydraulic press, and the like. Pressure is needed to penetrate the texturing layer of polyester release liner film, and the embossing tool can be heated to enhance the receptivity of the texturing layer of polyester release liner for texturing. Generally, heating the embossing tool will cause localized heating of the texturing surface in the areas of contact, i.e. the surface of the texturing layer of polyester release liner, to impart a better texture and to minimize the damage to the release coating during texturing. The texturing layer of polyester release liner can soften at elevated temperatures below 120° C. To achieve the significant depth into the texturing layer only surface heating is not sufficient and an overheating through surface may damage the surface and the texture dimensions may not achieved as desired. To overcome this issue a series of preheat rolls are used to transfer heat in steps so that at the time of texturing the maximum depth penetration achieved without damaging the surface of texturing layer because of over temperature. In addition optionally a infrared heater can be used across the release liner if the desired texture's depth dimension is high and it seems difficult transfer heat through surface cooling tactics. It is preferred to transfer texture at higher pressure then higher temperature so it is important to optimize texturing conditions so as to achieve the desired texture without damaging the texturing layer surface. The amount of texture that will be imparted to a release liner can depend upon different processing parameters such as the type of polymer used to make texturing layer, the micro texture design, the texturing pressure, the texture roll temperature, the type of texturing roll or tool, the hardness of the texturing roll, the hardness of the backup roll etc. The processing parameters need to be optimized to achieve the desired pattern in a release liner. For example a hard back uproll, ex. a steel roll, can produce a textured release liner with a smoother back side than a softer back uproll, ex. a rubber roller. In some cases, ex. when the release liner is relatively thin, using a soft backup roll can result in some protrusions on the backside caused by the high points or peaks in the texturing tool pushing the release liner in to the soft backup surface. If such a release liner is used with a film article having a high gloss top surface, a smooth backside may be desirable, especially if the resulting film article assembly is intended to be wound up in to a roll. If the release liner is used with a film article having a textured or matte top surface, the surface texture of the liner's back side may not be particularly important.

In a further aspect of the present invention, a method is provided for making an adhesive backed article assembly. The method comprises providing a textured biaxially oriented polyester release liner like that described above and providing a pressure sensitive adhesive. The adhesive articles have a continuous adhesive layer typically a pressure sensitive adhesive layer. The adhesive thickness layer typically had a thickness from about 8μ to 50μ. The coat weight of adhesive typically had a range of about 10 to 50 grams per square meter (gsm). The pressure sensitive adhesive can be any pressure sensitive adhesive known in the art. These include rubber based adhesive, acrylic adhesives, vinyl ether adhesives, silicone adhesives and mixture of two or more thereof. Included are the pressure sensitive adhesive materials described in “Adhesion and Bonding”, Encyclopedia of Polymer Science and Engineering, Vol1, Pages 476-546, Interscience Publishers, 2^{nd} edition 1985, the disclosure of which is hereby incorporated by reference. The pressure sensitive adhesive materials that are useful may contain as a major constituent an adhesive polymer such as acrylic type polymers, block copolymers, natural, reclaimed or styrene butadiene rubbers, tackified natural or synthetic rubbers, random copolymers of ethylene and vinyl acetate, ethylene vinyl acrylic terpolymers, polyisobutylene, poly(vinyl ether) etc. The pressure sensitive adhesive materials are typically characterized by glass transition temperatures in the range of about −70° C. to about 10° C. Other materials in addition to the foregoing resins may be included in the pressure sensitive adhesive materials. These include solid tackifying resins, liquid tackifying resins or liquid plasticizers. Particularly useful adhesives are described in U.S. Pat. Nos. 5,192,612 and 5,346,766 which are incorporated herein by reference.

The pressure sensitive adhesive can be applied using the standard coating techniques, such as curtain coating, gravure coating, Reverse gravure coating, Offset gravure coating, roller coating, brushing, knife over roll coating, air knife coating metering rod, doctor knife coating, dipping, die coating, spraying and the like. The application of these coating techniques is well known in the industry and can effectively be implemented by one skilled in the art. The knowledge and expertise of the manufacturing facility applying the coating determine the preferred method. Further information on coating methods can be found in “Modern Coating and Drying Technology”, by Edward Cohen and Edgar Gutoff, VCH Publishers, Inc., 1992.

The method also comprise bringing together the pressure sensitive adhesive and the textured release surface of the biaxially oriented polyester film release liner (ex. coating or otherwise applying the pressure sensitive adhesive on to the textured release surface and/or forcing the textured release surface in to the pressure sensitive adhesive) so as to form fluid egress channels in the pressure sensitive adhesive. The method can additionally comprise laminating or otherwise bonding together the pressure sensitive adhesive and the back of an article to form an adhesive backed article. The method can further comprise forming the adhesive backed article assembly by either performing the bonding together and then the bringing together or performing the bringing together and then the bonding together. The fluid egress channels define a textured bonding surface of the adhesive backed article having exit path ways, which preferably provide a continuous fluid egress to a periphery of the article, for fluid (ex. air) to egress out from behind the article when the textured bonding surface is adhered to or otherwise disposed on a substrate, and preferably when the article is adhered to a smooth surface on the substrate.

Referring to FIG. 8, a representative method of bringing together the pressure sensitive adhesive and the biaxially oriented polyester textured release liner. biaxially oriented polyester textured release liner unwinds at station (101) passed through a series of winding roller to a coating station (102) where an pressure sensitive adhesive is applied, then the said biaxially oriented polyester textured release liner coated pressure sensitive adhesive passes through an oven or dryer (103), just after coming out from oven the adhesive side of biaxially oriented polyester textured release liner comes on contact with a article which unwinds at station (105) and comes in contact with adhesive coated substrate through support of winding rollers and is forced via nip roll (104) with enough pressure to penetrate outwardly extended dimensions into the adhesive, this laminate of biaxially oriented polyester textured release liner and substrate coated with pressure sensitive adhesive then passed through series of winding rollers to wound in roll form at winding station (106).

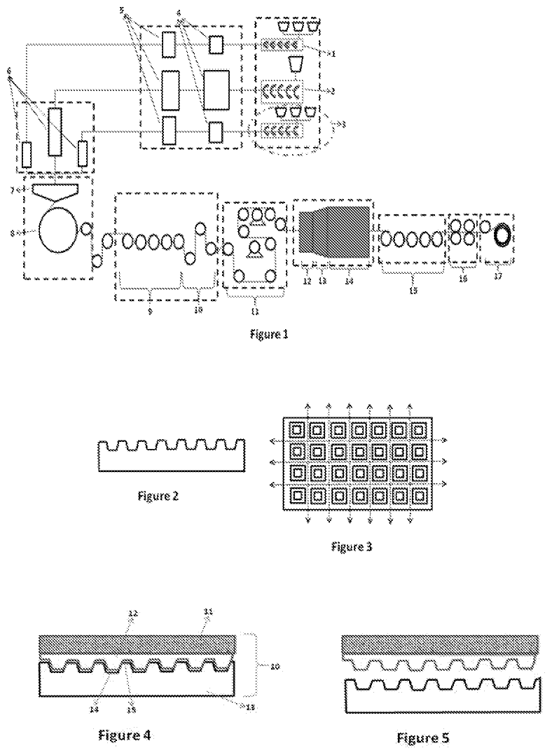

Referring to FIG. 4 & FIG. 5, an exemplary adhesive backed article assembly comprises a release liner having a release side that has been embossed using the tool (FIGS. 6 & 7). The FIG. 2 & FIG. 3 defining the imparted textures in the release liner. The article assembly (FIG. 4) is backed by a textured polyester film release liner. The article at the time of application i.e. removal or de-attachment of polyester film release liner (FIG. 5) shows the texture transfer from release liner to the pressure sensitive adhesive. The egress channels define exit path ways for fluid to egress from behind the article when the textured release liner is removed and the textured bonding surface is adhered to or otherwise disposed on the surface of a substrate.

Referring to FIG. 4, another exemplary adhesive backed article assembly 10 comprises a release liner 14 having a release side that has been textured using the tool as per FIGS. 6 and 7. The assembly 10 includes an article 11, such as a film, backed with a layer 12 of pressure sensitive adhesive, with the pressure sensitive layer 12 beings and sandwiched between the liner 13 and the article. The pattern formed in the release liner 13 is in the adhesive layer 12 so as to form a textured bonding surface on the adhesive 12 that will provide continuous fluid egress channels to a periphery of the article 11. The egress channels define exit path ways for fluid to egress from behind the article 11 when the textured release liner 13 is removed and the textured bonding surface is adhered to or otherwise disposed on the surface of a substrate. With textured polyester release liners according to the present invention, there is generally a loss of definition from the pattern on the original texturing tool to the texture transfer in the polyester release liner and, therefore, the texture of the textured bonding surface of the pressure sensitive adhesive layer. The present invention also shows an improvement in achieving the dimension or feature after the texturing so the textured bonding surface of the pressure sensitive adhesive layer will look similar to the tool. Unlike to the prior arts where there is a loss during texturing or feature or dimension in the release liner used of paper refer WO 2005/052082, when the liner is textured, the feature transferred in the liner may lose some of the definition of the tool. When the adhesive is coated on to the liner, the adhesive may also loses some of the definition of the liner.

Release Coating in the present inventive biaxially oriented polyester release liner can be coated inline i.e. during manufacturing of biaxially oriented polyester film line as well offline coating i.e. after producing the biaxially oriented polyester film with a suitable release material. Inline coating needs to be strictly a water borne system while an offline coating have flexibility to use different systems ex. Solvent borne, Ultra Violet (UV) curable systems etc. Generally, suitable materials are selected to release from the pressure sensitive adhesive that is used, and those skilled in the art are capable of selecting the proper release material for the pressure sensitive adhesive. Some release coatings are releasable only from certain classes of pressure sensitive adhesives while some are more universal and either are suitable. Suitable release materials can include silicones, fluorosilicones, urethanes and fluoropolymers. Silicones are desirable for their availability and examples are thermal cured such as those cured with platinum, tin, rhodium, or radiation cured (ex. E-beam, UV light etc.) and may be solvent based or solvent free materials. The release coating may be applied on one or both sides of the release liner, and may be the same release material or a different release material. Differential release liners can provide a tighter release on the side with embossed texture than on the back side so that when the liner is adhesive coated and wound in to a roll, the adhesive will remain on the embossed side to protect the textures while the adhesive is laminated to a substrate.

Adhesive Coating The biaxially oriented polyester release liner is suitable for use with a pressure sensitive adhesive. Pressure sensitive adhesives are generally known and any suitable pressure sensitive adhesive may be used with the appropriate release coating. The adhesive can be solvent based or an emulsion that is coated on to the textured side of the release liner. The solvent or water is dried off, for example, in an oven and the adhesive may be crosslinked. The pressure sensitive adhesive may be coated on to a substrate and the liner is laminated on to the pressure sensitive adhesive to serve as a protective liner as well as a texturing tool. The rheology of the adhesive may be controlled as needed. If it is desirable to retain the features, and the channels between them after the adhesive coated product has been applied to a substrate, as higher modulus pressure sensitive adhesive or more highly crosslinked adhesive may be used. If it is desirable for the adhesive features to flow together and close the channels between them, a softer or lower modulus adhesive may be used.

Articles that can be used with the present invention can be applied to a variety of surfaces and substrates. Such surfaces can include those that are relatively rough surfaces, smooth air-tight surfaces, uneven surfaces and flat surfaces. It is important to match a specific pressure sensitive adhesive to a substrate in order to achieve the desired level of adhesion. Examples of suitable substrates can include glass, metal, plastic, wood, and ceramic substrates, and painted or otherwise coated surfaces of these substrates. Representative plastic substrates can include polyvinylchloride, ethylene-propylenediene. Monomer rubber, polyurethanes, polymethyl methacrylate, engineering thermoplastics (ex. polyphenyleneoxide, polyetheretherketone, polycarbonate), and thermoplastic elastomers.

The substrates can be generally smooth surfaced substrates that accentuate the need for an article with fluid egress. Substrates with rough surfaces typically provide an inherent egress for fluids trapped at an interface of an applied article because the rough surface permits fluid flow. In the application of the adhesive backed article, the article is typically positioned over the substrate. The microtextured adhesive surface can be such as to enable the movement of the adhesive backed article about the surface of the substrate until pressure is applied to enable adhesive contact and wet out of the adhesive on the surface of the substrate. The appropriate level of pressure and resulting wet out will create a bond between the adhesive and the substrate. Upon forceful application of the adhesive backed article, the channels can permit air to egress around the periphery of the article, there by eliminating air bubbles being trapped between the article and the substrate. Additionally, the microtexture features of the pressure sensitive adhesive can be such as to atleast partially collapse during application of the adhesive backed article, which can increase the amount of adhesive in contact with the substrate. The partial disappearance of the channels can indicate that the article has a desirable level of adhesion to the substrate.

### Test Methods

### Amount of Curl in the Release Liner

The term “given amount of curl” denotes in the present invention a longitudinal curl of the release liner atleast equal to 5 mm, if measured in accordance with test method as defined in the International standard ISO 18910:2000 for the determination of the curl of photographic film and paper. This test method is particularly intended for film in sheet form or microfiche format, and it is a practical way of measurement that combines the effects of film curl with gravity. According to the test procedure, a sheet to be measured is placed with the concave side upwardly on a horizontal table after the conditioning and without removing the sheet from the conditioned environment. The distance between the four corners of the test sheet and the table is measured in millimeters to the nearest millimeter, and then the arithmetical average value is calculated. The film sheet measured 4 inches by 6 inches in the present measurements.

### Thickness Uniformity of the Release Liner

Equipment: Mahr Militron
Test Procedure: Samples were taken in approx 50 mm wide strip along with the width (i.e. in cross machine direction) of 3 different layers from the roll and measured the release liner thickness from one edge to other at various points at a distance of approx. 40-50 mm. The measured values were recorded and average taken of 10 maximum and 10 minimum and % thickness variation calculated according to below formula:

Thickness Variation %=(T1−T2)*100/T0
T0=Thickness of the release liner in micron (set)
T1=Average thickness of 10 maximum measured values in micron
T2=Average thickness of 10 minimum measured values in micron

### Tensile Strength of the Release Liner

Equipment: Tensile tester (LLOYD-LRX)
Test standard: ASTM D-882
Procedure: 2 samples each of 25 mm wide and 150 mm long were taken each from each side and center of the release liner, in machine and cross machine or transverse direction with help of a standard template and sharp blade to avoid notches on the edge after leaving 250 mm from edge. Sample was uniform in width along its length and should be free from crease, wrinkles and notches. LRX machine is used to test tensile strength of release liner, gauge length kept 100 mm and sample mounted between the Jaws in such a way that the centerline of the sample should coincide exactly the centerline passing through the grips; stretch the sample at 50 mm/min speed. The test results were averaged each in machine and transverse direction of release liner.

Heat Shrinkage of the Release Liner
Equipment: A mechanical oven capable of maintaining a temperature of 200° C. Length Measuring Scale graduated in 0.5 mm divisions 30 cm or more in length.
Test standard: ASTM D-1204
Test Procedure: 3 samples were taken form each edge and center from release liner film Roll after leaving 250 mm from each edge. Reference lines markd in center in both machine and transverse direction of each sample and measured the initial length and width dimensions. The samples then placed in between two heavy paper sheets having talc powder on the surface in contact with film kept in oven at preheated oven at 150° C. for 30 minutes. After conditioning at said conditions the samples were taken out from oven and conditioned at lab condition. Then length and width dimensions were measured at each reference line of the samples to the nearest of 0.5 mm.

% Linear Shrinkage=(Do−Df)*100/Do CALCULATION:
Do=Initial dimension (Length or width) of specimen in mm
Df=Final dimension (Length or width) of specimen in mm

Thickness of Texture Layer of Release Liner
Equipment: Mahr Militron
Test Procedure: Samples were taken in approx 50 mm wide strip along with the width (i.e. in cross machine direction) of 3 different layers from the roll and measured the release liner thickness in micrometers from one edge to other at each edges leaving 250 mm at each edge and center. The measured values of thickness were recorded as T1. Then Apply 1.4 Dioxan on Texturing side of release liner film at similar position where thickness values were taken & rub with tissue paper, it results removal of copolyester layer of the release liner film. Then again measure the thickness of release liner at positions from where the copolyester layer is removed. The measured values of thickness in micrometers were recorded as T2. The thickness of texture layer is calculated as: T1−T2

Haze of the Release Liner
Equipment: Haze guard system
Test standard: ASTM-D-1003
Test Procedure: A sample was taken in 80 mm strip of full width across the cross machine direction. The haze value of the sample points tested across the width and averaged.

Texture Transfer Appearance on the Release Liner
Equipment: Metallux 3 microscope
Test Procedure: Random samples were taken from different positions of roll after texturing of release liner and viewed through microscope. Samples examined with enough magnification so that all the dimensions of texture seen clear. If the textural dimensions can be seen sharply without or slight distortion on one dimension at the sharp edges the sample will be rated as Good. If there is distortion on 2 or more sharp edges the sample will be rated as Poor.

Release Force of Release Liner
Equipment: Cheminstrument AR 1000
Test Procedure: Pressure sensitive adhesive tape (TESA 7475) was laminated on PET film (release coated side of release liner) and rolled twice in each direction with a laminating roller (2.5 kg). After that 3 test strips were prepared (1 inch×10 inch) for each trials and kept for 24 hrs for aging. Release value was checked with Cheminstrument AR 100—Release tester after 24 hrs. The peel was at 180° at a rate of 300 mm/min.

### Example 1

The biaxially oriented release liner polyester film is prepared in a ABC structure in a thickness of 50μ, the core layer B comprises only homopolyester where as the surface layer C comprises a blend of homopolyester and antiblock masterbatch commercially available by grade Tdc S616 by Sukano having average particle size of 0.911. The antiblock used in a in a amount of 2000 ppm of SiO2 in the surface layer C. The other surface layer A comprises copolyester and antiblock masterbatch commercially available by grade Tdc S616 by Sukano having average particle size of 0.911. The antiblock used in a in a amount of 1000 ppm of SiO2 in the surface layer A. The extruder throughput of melt maintained to keep layer A thickness more than 4μ. In present example the throughput of extruders kept 300 kg/hr, 1450 Kg/hr & 250 Kg/hr respectively for extruder A, B & C. The combination of above polymers then extruded at a temperature of 255° C. to produce melt stream, Melt stream A & C fed through joining zone to laminate to the core melt stream B as its surfaces. The laminate produced a 3 layer coextruded structure where the polymers of each layer are as described above. The extruded polymer was delivered through the die in form of molten stream. The resulting melt stream then quenched on a chill roll by electrostatic pinning and then stretched through a series of hot rollers heated at 92° with stretching in machine direction at a draw ration of 3.0 times then cooled by a series of cooled rollers at a temperature of 40° C. Uniaxially oriented polyester release liner film is then coated by water borne silicone release coating. The coating is then dried and stretched in transverse direction at a draw ration of 4.0 at 95° C. The biaxially oriented release liner then annealed or heat set at around 240° C. and winded in a roll. The homopolymer of polyester was polymerize by a known method. A melt slurry of ethylene glycol and purified tereththalic acid was heated in presence of esterification catalyst antimony trioxide at 0.04 wt % and triphenyl phosphate at 0.07 wt % at 260° C. with water. Excess ethylene glycol was removed under vacuum leaving a residual melt of homopolyester. The melt was dischsrged by strand die into a cooling trough, palletized and then further dried to remove the residual moisture to less than 50 ppm. The intrinsic viscosity of homopolyester was 0.60 to 0.66. The copolymer of polyester used is a copolymer produced by Isophthalic acid and coterephtahalic acid random copolyester with an IV 0.65, isophthalic acid a mole ratio of 18% and terephthalic acid in a mole ratio of 82% polymerized to produce copolyester. Commercially available grades of such copolyesters are ACoPET 2200 by JBF Industries & Selar 8306 by Dupont. Alternatively a copolyester consisting a random copolymer of cyclohexane dimethanol can be utilize, commercially available from Eastman Chemicals of intrinsic viscosity about 0.70. Uniaxially oriented polyester release liner film is coated by water borne silicone release coating as per the following coating formulation:

| Chemical | Quantity in Kg |
|---|---|
| Silicone emulsion Syl-off 7934 | 34.4 |
| Catalyst emulsion Syl-off 7975 | 5.6 |
| Antifoaming Additive Syl-off 7989 | 0.015 |
| Wetting additive Syl-off 67 | 0.05 |
| water | 60 |

The above biaxially oriented release liner polyester film then subjected to texturing in a texturing machine which is equipped with series of oil heating rollers and a texturing station which consist of a removal assembly of texturing tool in form of roller, backed by a steel roller with hydraulic pressure. An optional infrared heater is used across the width to provide an additional heat the make surface more receptive for dimensional changes. The texturing tool (FIG. 6 and FIG. 7) in form of roller is having dimensions A=170μ B=170μ, C=30μ, D=30μ & E=9μ. The nip steel roll pressure applied 250 Nt/cm² and infrared temperature maintained at 180° C. The texturing process carried out 10 mtr/min.

### Example 2

The biaxially oriented release liner polyester film is prepared in a AB structure in a thickness of 50μ, the core layer B comprises a blend of homopolyester and antiblock masterbatch commercially available by grade Tdc 5615 by Sukano having average particle size of 1.4μ. The antiblock used in a in a amount of 1000 ppm of SiO2. The other surface layer A comprises copolyester and antiblock masterbatch commercially available by grade Tdc 5616 by Sukano having average particle size of 0.9μ. The antiblock used in a in a amount of 1000 ppm of SiO2 in the surface layer A. The extruder throughput of melt maintained to keep layer A thickness more than 4μ. The layer ratio of surface layer with respect to core layer was 18%. The combination of above polymers then extruded at a temperature of 255° C. to produce melt stream, Melt stream A fed through joining zone to laminate to the core melt stream B as its surfaces. The laminate produced a 2 layer coextruded structure where the polymers of each layer are as described above. The extruded polymer was delivered through the die in form of molten stream. The resulting melt stream then quenched on a chill roll by electrostatic pinning and then stretched through a series of hot rollers heated at 92° with stretching in machine direction at a draw ration of 3.0 times then cooled by a series of cooled rollers at a temperature of 40° C. Uniaxially oriented polyester release liner film is then coated by water borne silicone release coating. The coating is then dried and stretched in transverse direction at a draw ration of 4.0 at 95° C. The biaxially oriented release liner then annealed or heat set at around 240° C. and winded in a roll. The homopolymer of polyester was polymerize by a known method. A melt slurry of ethylene glycol and purified tereththalic acid was heated in presence of esterification catalyst antimony trioxide at 0.04 wt % and triphenyl phosphate at 0.07 wt % at 260° C. with water. Excess ethylene glycol was removed under vacuum leaving a residual melt of homopolyester. The melt was dischsrged by strand die into a cooling trough, palletized and then further dried to remove the residual moisture to less than 50 ppm. The intrinsic viscosity of homopolyester was 0.60 to 0.66. The copolymer of polyester used is a copolymer produced by Isophthalic acid and coterephtahalic acid random copolyester with an IV 0.65, isophthalic acid a mole ratio of 18% and terephthalic acid in a mole ratio of 82% polymerized to produce copolyester. Commercially available grades of such copolyesters are ACoPET 2200 by JBF Industries & Selar 8306 by Dupont. Alternatively a copolyester consisting a random copolymer of cyclohexane dimethanol can be utilize, commercially available from Eastman Chemicals of intrinsic viscosity about 0.70. Uniaxially oriented polyester release liner film is coated by water borne silicone release coating as per the following coating formulation:

| Chemical | Quantity in Kg |
|---|---|
| Silicone emulsion Syl-off 7934 | 34.4 |
| Catalyst emulsion Syl-off 7975 | 5.6 |
| Antifoaming Additive Syl-off 7989 | 0.015 |
| Wetting additive Syl-off 67 | 0.05 |
| water | 60 |

The above biaxially oriented release liner polyester film then subjected to texturing in a texturing machine which is equipped with series of oil heating rollers and a texturing station which consist of a removal assembly of texturing tool in form of roller, backed by a steel roller with hydraulic pressure. An optional infrared heater is used across the width to provide an additional heat the make surface more receptive for dimensional changes. The texturing tool (FIG. 6 and FIG. 7) in form of roller is having dimensions A=170μ, B=170μ, C=30μ, D=30μ & E=9 μl. The nip steel roll pressure applied 250 Nt/cm² and infrared temperature maintained at 150° C. The texturing process carried out 10 mtr/min.

### Example 3

Example 1 was repeated except in increasing the temperature of infrared heater to 180° C. from 150° C. and pressure on texturing tool from 150 Bar to 200 Bar, anticipating to achieve the more depth of texture.

### Example 4

Example 1 was repeated except in increasing the temperature of infrared heater to 180° C. from 150° C. and pressure on texturing tool from 150 Bar to 200 Bar, anticipating to achieve the more depth of texture.

The produced samples tested and results were averaged,

The tested results are summarized in below table:

| Property | Unit of measurement | Example 1 | Example 2 | Example 3 | Example 4 |
|---|---|---|---|---|---|
| Release liner | % | 1.2 | 2 | 1.2 | 2 |
| thickness variation | | | | | |
| Tensile strength of | Kg/cm² | 1800/1900 | 1780/1900 | 1800/1900 | 1780/1900 |
| release liner before | | | | | |
| texturing (MD/TD) | | | | | |
| Tensile strength of | Kg/cm² | 1800/1900 | 1780/1900 | 1800/1900 | 1780/1900 |
| release liner after | | | | | |
| texturing (MD/TD) | | | | | |
| Heat shrinkage of | mm at | 2.2/0.2 | 2.2/0.2 | 2.2/0.2 | 2.2/0.2 |
| release liner | 150° C./30 min | | | | |
| (MD/TD) | | | | | |
| Curl before texturing | mm | Nil | Nil | Nil | Nil |
| Curl before texturing | mm | Nil | Nil | Nil | Nil |
| Texturing layer | μ | 7.2 | 9.1 | 7.2 | 9.1 |
| thickness | | | | | |
| Release force | g/inch | 22 | 28 | 22 | 28 |
| Appearance of | Visual | Good | Good | Good | Good |
| Textured surface | | | | | |

From the above disclosure of the general principles of the present inventive and the preceding detailed description, those skilled in this art will readily comprehend the various modifications, rearrangements and substitutions to which the present invention is susceptible. Therefore, the scope of the invention should be limited only by the following claims and equivalents thereof.

1. A biaxially oriented polyester release liner film having uniform micro textured surface for preparing an article backed with a pressure sensitive adhesive, said liner comprising:
a layer of biaxially oriented polyester film having a release side with a micro textured surface,
the texture support layer is a biaxially oriented layer and is a part of biaxially oriented polyester film and not an added layer of unlike polymers, and a back side, and
a release material is bonded with said texture support layer, wherein the texture created in said texture support layer is dimensioned so as to form fluid egress channels in the bonding surface of the pressure sensitive adhesive,
when the said textured release surface is forced into the bonding surface of the pressure sensitive adhesive coated article, such that the fluid egress channels defines a textured bonding surface having exit pathways for at least some of the fluid to egress from behind the article when the article is adhered to a substrate
and wherein said biaxially oriented polyester release liner may or may not comprises a functional material on said back side of biaxially oriented polyester release liner.

2. The release liner as claimed in claim 1, wherein said pattern comprises a plurality of outwardly extending protrusions that are sized and shaped so as to penetrate and form fluid egress channels in the pressure sensitive adhesive.

3. The release liner as claimed in claim 1, wherein said biaxially oriented polyester release liner has a thickness in a range from 20 μm to about 250 μm.

4. The release liner as claimed in claim 1, wherein the said biaxially oriented polyester release liner has a thickness of texturing layer minimum 4μ.

5. (canceled)

6. The release liner as claimed in claim 1, wherein said backside of said biaxially oriented polyester release liner is relatively flat.

7. The release liner as claimed in claim 1, wherein the texture formed in said biaxially oriented polyester release liner shall reduce the volume of textured layer by maximum 90.25% so as to form such fluid egress channels and define a volume of atleast 0.028 μm³ per 1 μm³ of textured layer volume. The said textures have atleast one dimension more than 10 micrometers.

8. The release liner as claimed in claim 1, wherein the texture formed in said biaxially oriented polyester release liner is operatively adapted, when the pressure sensitive adhesive is applied onto said textured release surface so as to form such fluid egress channels that will be substantially undetectable on an upper side surface of the article, after final application of the article onto a substrate, when the article is an adhesive backed compliant film.

9. (canceled)

10. (canceled)

11. The release liner as claimed in claim 10, where in the release material is water borne or UV curable or solvent borne release material.

12. The release liner as claimed in claim 1, where the said textured surface of the biaxially oriented polyester release liner is micro textured release surface.

13. The release liner as claimed in claim 1, wherein the texture formed in said biaxially oriented polyester release liner is dimensioned so as to form fluid egress channels in the bonding surface of the pressure adhesive, when the pressure sensitive adhesive is applied to said textured release surface.

14. The release liner as claimed in claim 1, wherein the texture formed in said biaxially oriented polyester release liner is dimensioned so as to form fluid egress channels in the bonding surface of the pressure adhesive, when said textured release surface is forced into the bonding surface of the pressure sensitive adhesive.

15. A method of making a textured biaxially oriented polyester release liner for use with an article backed with a pressure sensitive adhesive, said method comprising:
providing a layer of polyester film having a release side with a micro textured surface, the texture support layer is a biaxially oriented layer and is a part of biaxially oriented polyester film and not an added layer of unlike polymers, and a back side, and a release material is bonded with said texture support layer, wherein the texture created in said texture support layer is dimensioned so as to form fluid egress channels in the bonding surface of the pressure sensitive adhesive, when the said textured release surface is forced into the bonding surface of the pressure sensitive adhesive coated article, such that the fluid egress channels defines a textured bonding surface having exit pathways for atleast some of the fluid to egress from behind the article when the article is adhered to a substrate, and providing a release material on the release side of the liner, either before or after forming of the textured release surface, and
wherein said biaxially oriented polyester release liner may or may not comprises a functional material on said back side of biaxially oriented polyester release liner.

16. (canceled)

17. The method of making a textured biaxially oriented polyester release liner as claimed in claim 15, where the said textured surface of the biaxially oriented polyester release liner is micro textured release surface.

18. An adhesive backed article assembly in combination with a release liner and a pressure sensitive adhesive, wherein the release liner is biaxially oriented polyester release liner and the texture formed in said biaxially oriented polyester release liner is applied in said adhesive so as to form a textured bonding surface on said adhesive with fluid egress channels that define exit pathways for fluid to egress from behind the said article when said textured bonding surface disposed on a substrate.

19. The article assembly as claimed in claim 18, wherein said pattern provides a plurality of outwardly extending protrusions that penetrate and form said fluid egress channels in the textured bonding surface of said adhesive.

20. The article assembly as claimed in claim 19, wherein the texture formed in said biaxially oriented polyester release liner shall reduce its volume maximum by 90.25% so as to form such fluid egress channels and define a volume of atleast 0.028 μm³ per 1 μm³ of textured layer volume. The said textures have atleast one dimension more than 10 micrometers.

21. The article assembly as claimed in claim 19, wherein said article is a compliant film having an upper surface and said fluid egress channels are imposed by the texture of said biaxially oriented polyester release liner so as to be substantially undetectable on the upper surface of the said film, after final application of said film onto a substrate.

22. The article assembly as claimed in claim 18, wherein said assembly has a thickness in a range from about 50 μm to about 500 μm.

23. A method of making an adhesive backed article assembly, said method comprising:
providing textured biaxially oriented polyester release liner according to claim 1, providing a pressure sensitive adhesive, bringing together the pressure sensitive adhesive and the textured release surface of biaxially oriented polyester release liner so as to form fluid egress channels in the pressure sensitive adhesive, bonding together the pressure sensitive adhesive and the back of an article to form an adhesive backed article, and forming the adhesive backed article assembly by either performing bonding together and then bringing together, wherein the fluid egress channels at least partially define a structural bonding surface of the adhesive backed article having egress channels for fluid to egress from behind the article when textured bonding surface is disposed on a substrate.

24. The method as claimed in claim 23, further comprising curing the pressure sensitive adhesive after said bringing together or after forming of the adhesive backed article assembly.

25. (canceled)
